(19) United States
(12) Patent Application Publication
(10) Pub. No.: US 2024/0110074 A1
(43) Pub. Date: Apr. 4, 2024

(54) INK SET

(71) Applicant: RISO KAGAKU CORPORATION, Tokyo (JP)

(72) Inventors: Ryo SHINOTSUKA, Tokyo (JP); Takumi MATSUDA, Tokyo (JP)

(21) Appl. No.: 18/474,625

(22) Filed: Sep. 26, 2023

(30) Foreign Application Priority Data
Sep. 29, 2022 (JP) 2022-156321
Sep. 19, 2023 (JP) 2023-151495

(51) Int. Cl. C09D 11/40; C09D 7/00; C09D 11/54

(52) U.S. Cl. CPC C09D 11/40; C09D 7/71; C09D 11/54

(57) ABSTRACT

Disclosed is an ink set including: an inkjet pretreatment liquid containing an aggregating agent; an inkjet ink; and a cleaning liquid that contains water, a water-soluble organic solvent, a surfactant with an HLB value of 10 or more, and a metal salt A, and has a conductivity of 0.10 to 3.0 mS/cm at 5° C. A method for producing a printed textile item is also disclosed.

### CROSS REFERENCE TO RELATED APPLICATIONS

This application is based upon and claims the benefit of priority from the prior Japanese Patent Application No. 2022-156321, filed on Sep. 29, 2022, the entire contents of which are incorporated by reference herein, and the prior Japanese Patent Application No. 2023-151495, filed on Sep. 19, 2023, the entire contents of which are incorporated by reference herein.

### BACKGROUND OF THE INVENTION

### Field of the Invention

Embodiments of the present disclosure relate to an ink set.

### Description of the Related Art

An ink jet recording method is a printing method in which a liquid ink having high fluidity is jetted from fine nozzles and adhered to a substrate to thereby perform printing. This method enables printing of high-resolution and high-quality images to be conducted at high speed and with little noise using a relatively inexpensive device, and has therefore rapidly become widespread in recent years. In terms of inks, aqueous-type inks have become widespread since it is possible to obtain a printed matter having high image quality at low cost. Aqueous inks have enhanced drying properties due to containing water, and also have an advantage of excellent environmental friendliness.

In one example of a method for when an aqueous ink is used, a substrate is treated using a pretreatment agent containing an aggregating agent and then the aqueous ink is applied.

In inkjet printing, due to inks and the like sticking at jetting ports of nozzles of an inkjet head, jetting faults such as misalignment of the jetting directions of inks from the nozzles and non-jetting may be caused. To avoid this, the inkjet head and the like are generally cleaned.

JP 2014-79932 A discloses a maintenance liquid containing an alkylene oxide adduct of acetylene glycol in which the main chain carbon number is 12 or more, acetylene glycol in which the main chain carbon number is 10 or more, and polyoxyalkylene alkyl ether, and discloses that due to the maintenance liquid, minute air bubbles caused during ink filling can be prevented and filling and jetting faults in the inkjet head are remediated.

### SUMMARY OF THE INVENTION

An embodiment of the present invention relates to an ink set including: an inkjet pretreatment liquid containing an aggregating agent; an inkjet ink; and a cleaning liquid that contains water, a water-soluble organic solvent, a surfactant with an HLB value of 10 or more, and a metal salt A, and has a conductivity of 0.10 to 3.0 mS/cm at 5° C.

### DETAILED DESCRIPTION OF THE EMBODIMENTS

Embodiments of the present invention will be described below in detail, but needless to say, the present invention is not limited to these embodiments, and various modifications and alterations are possible.

An ink set according to one embodiment is an ink set including: an inkjet pretreatment liquid (hereinafter sometimes simply referred to as “pretreatment liquid”) containing an aggregating agent; an inkjet ink (hereinafter sometimes simply referred to as “ink”); and a cleaning liquid that contains water, a water-soluble organic solvent, a surfactant with an HLB value of 10 or more, and a metal salt A, and has a conductivity of 0.10 to 3.0 mS/cm at 5° C.

Stable jetting of the pretreatment liquid and ink by means of an inkjet method is advantageous in terms of stable quality and the like. Cleaning the paths and the like may be effective for a fault in jetting from an inkjet head. However, when the pretreatment liquid and ink are jetted by means of an inkjet method, it is desirable that good cleaning effects can be obtained for both the ink and pretreatment liquid in cleaning the paths of the ink and pretreatment liquid, the inkjet head, and the like.

In order to obtain a good cleaning effect in cleaning the paths and the like, it is preferable that the cleaning liquid can mix well with each of the ink and pretreatment liquid and that there is little occurrence of foreign matter due to mixing of the cleaning liquid with each of the ink and pretreatment liquid, that is, it is preferable that the mixing stability is good. Crystalline foreign matter caused by aggregated components of the pretreatment liquid may be generated, and this may cause clogging of the nozzle of the inkjet head, for example. Due to such crystalline foreign matter, cleaning may not be performed sufficiently with a cleaning liquid for ink, for example.

In the ink set of one embodiment, the storage stability of the cleaning liquid is excellent, and when this ink set is used, an excellent cleaning effect for both the pretreatment liquid and ink may be possible in cleaning. While not constrained by theory, the reasons for this are speculated to be as follows.

The aggregating agent contained in the pretreatment liquid often has a high polarity, and such an aggregating agent generally tends to be difficult to disperse or dissolve in a low polarity environment. If the conductivity of the cleaning liquid at 5° C. is 0.10 mS/cm or more, a state having a certain degree of high polarity can be easily maintained when the cleaning liquid and the pretreatment liquid are mixed, the aggregating agent can be easily dispersed or dissolved, and the cleaning properties of the pretreatment liquid can be enhanced.

If the conductivity of the cleaning liquid at 5° C. is 3.0 mS/cm or less, when the cleaning liquid and the ink are mixed, aggregation of the ink components is unlikely to occur, and this can contribute to good cleaning properties for the ink.

When the cleaning liquid contains a surfactant with an HLB value of 10 or more, insoluble matter is less likely to occur when the cleaning liquid and the pretreatment liquid are mixed, and this may contribute to good cleaning properties for the pretreatment liquid.

Meanwhile, a surfactant with a relatively high HLB value of 10 or more may precipitate if the polarity of the cleaning liquid is excessively low. If the conductivity of the cleaning liquid at 5° C. is 0.10 mS/cm or more, the polarity of the cleaning liquid does not become too low and it is difficult for the surfactant to precipitate. Further, if the polarity of the cleaning liquid is too high, the storage stability of the cleaning liquid may deteriorate. If the conductivity of the cleaning liquid at 5° C. is 3.0 mS/cm or less, the polarity of the cleaning liquid is not too high and good storage stability is easily obtained.

<Inkjet Pretreatment Liquid>

An ink set of one embodiment can contain an inkjet pretreatment liquid.

The pretreatment liquid can contain an aggregating agent.

As the aggregating agent, a component having an action of aggregating the colorant and the like contained in the ink can be used. As the aggregating agent, a polyvalent metal salt, a cationic polymer, an organic acid, or a combination thereof can be used, for example.

A polyvalent metal ion of the polyvalent metal salt is not particularly limited as long as it is a divalent or higher metal ion. Examples of the polyvalent metal ion include a calcium ion, magnesium ion, copper ion, nickel ion, zinc ion, barium ion, aluminum ion, yttrium ion, and the like. A calcium ion and magnesium ion are more preferable because the reactivity tends to be higher when the ionic radius is small.

Examples of the anions of the polyvalent metal salt include chloride ion (Cl⁻), nitrate ion (NO₃⁻), acetate ion (CH₃COO⁻), iodide ion (I⁻), bromide ion (Br⁻), chlorate ion (ClO₃⁻), and sulfate ion (SO₄²⁻).

Examples of the polyvalent metal salt include nitrates, acetates, halides (for example, chloride, iodide, bromide, and the like), chlorates, sulfates, and the like.

Examples of the polyvalent metal salt include calcium chloride, calcium nitrate, magnesium nitrate, magnesium sulfate, copper nitrate, calcium acetate, magnesium acetate, and the like.

The polyvalent metal salt may be a hydrate or anhydrate.

A single polyvalent metal salt may be used alone, or a combination of two or more polyvalent metal salts may be used.

As the cationic polymer, a cationic water-soluble resin or a cationic water-dispersible resin may be used, for example, or a combination thereof may be used.

Specifically, examples of the cationic polymer includes polyethyleneimine (PEI), polyvinylamine, polyallylamine and salts thereof, polyvinylpyridine, and copolymers of cationic acrylamide. Examples of the cationic polymer include epichlorohydrin-amine polycondensate, polydiallyldimethylammonium chloride, and the like.

An example of a commercially available product of the cationic polymer is Himax SC-506 of HYMO Co., Ltd.

A single cationic polymer may be used alone, or a combination of two or more cationic polymers may be used.

Examples of the organic acid include formic acid, acetic acid, propionic acid, butyric acid, isobutyric acid, valeric acid, isovaleric acid, oxalic acid, malonic acid, succinic acid, glutaric acid, maleic acid, fumaric acid, citraconic acid, itaconic acid, tricarballylic acid, glycolic acid, thioglycolic acid, lactic acid, malic acid, tartaric acid, citric acid, isocitric acid, gluconic acid, pyruvic acid, oxalacetic acid, diglycolic acid, benzoic acid, phthalic acid, mandelic acid, salicylic acid, and polyacrylic acid.

One of these may be used alone, or a combination of two or more may be used.

The pretreatment liquid may contain a single aggregating agent alone or a combination of two or more aggregating agents.

The amount of the aggregating agent, expressed as the active component amount, relative to the total amount of the pretreatment liquid is preferably at least 1% by mass, more preferably at least 10% by mass, and even more preferably at least 15% by mass. The amount of the aggregating agent, expressed as the active component amount, relative to the total amount of the pretreatment liquid is preferably not more than 50% by mass, more preferably not more than 40% by mass, and even more preferably not more than 35% by mass. The amount of the aggregating agent, expressed as the active component amount, relative to the total amount of the pretreatment liquid is preferably 1% to 50% by mass, more preferably 10% to 40% by mass, and even more preferably 15% to 35% by mass.

In those cases where a metal salt hydrate is used as the metal salt in the present specification, the amount of the metal salt (the active component amount) refers to the equivalent amount of anhydrous salt. The same applies to amounts of metal salt below.

The pretreatment liquid preferably contains water, and the main solvent may be water.

There are no particular limitations on the water, but water containing as few ionic components as possible is preferred. Examples of the water include ion-exchanged water, distilled water, and ultrapure water.

From the viewpoint of viscosity adjustment, the amount of water contained relative to the total amount of the pretreatment liquid is preferably 20% to 80% by mass, more preferably 30% to 80% by mass, and even more preferably 40% to 70% by mass.

The pretreatment liquid preferably contains a water-soluble organic solvent. Organic compounds that are liquid at room temperature and can be dissolved in water can be used as the water-soluble organic solvent, and the use of a water-soluble organic solvent that mixes uniformly with an equal volume of water at 1 atmosphere and 20° C. is preferred. Examples of water-soluble organic solvents that may be used include lower alcohols such as methanol, ethanol, 1-propanol, isopropanol, 1-butanol, 2-butanol, isobutanol, and 2-methyl-2-propanol; glycols such as ethylene glycol, diethylene glycol, triethylene glycol, tetraethylene glycol, polyethylene glycol, propylene glycol, dipropylene glycol, tripropylene glycol, and polypropylene glycol; glycerols such as glycerol, diglycerol, triglycerol, and polyglycerol; acetins such as monoacetin and diacetin; glycol ethers such as ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, tetraethylene glycol monomethyl ether, tetraethylene glycol monoethyl ether, tetraethylene glycol dimethyl ether, and tetraethylene glycol diethyl ether; as well as triethanolamine, 1-methyl-2-pyrrolidone, 1,3-dimethyl-2-imidazolidinone, β-thiodiglycol, and sulfolane. The boiling point of the water-soluble organic solvent is preferably at least 100° C., and more preferably at least 150° C.

One of these water-soluble organic solvents may be used alone, or a combination of two or more water-soluble organic solvents may be used provided that the solvents form a single phase with water.

The amount of the water-soluble organic solvent in the pretreatment liquid relative to the total amount of the pretreatment liquid is preferably 5% to 50% by mass and more preferably 10% to 35% by mass.

The pretreatment liquid preferably contains a surfactant.

Examples of surfactants that may be preferably used include anionic surfactants, cationic surfactants, amphoteric surfactants, and nonionic surfactants, and one type or a combination of two or more types thereof may be used. Among these, nonionic surfactants are particularly preferred. The surfactant may be, for example, a low-molecular weight surfactant or a polymer-based surfactant.

The HLB value of the surfactant is preferably within a range from 5 to 20, and more preferably from 10 to 18.

The HLB value is one of the measures showing the properties of the surfactant and is a numerical value of the balance between a hydrophilic group and an oleophilic group in a molecule. The HLB value, which is proposed by means of several calculation methods, is a value calculated by means of the Griffin method in the present specification and is calculated by using the following formula (1). The same applies for the HLB value of the surfactant below.

HLB value=20×(formula weight of hydrophilic part)/(molecular weight of surfactant) formula (1)

The “hydrophilic part” indicates a hydrophilic portion contained in the molecular structure of the surfactant, and is preferably a polyoxyalkylene group, an alcohol group in which the main chain carbon number relative to a hydroxyl group is 3 or less, or a combination thereof. If the surfactant contains more than one hydrophilic portion, the formula weight of the hydrophilic part in formula (1) above is the sum of these.

Examples of the polyoxyalkylene group include a polyoxyethylene group (polyethylene oxide; EO: —(CH₂CH₂O)ₙ—), a polyoxypropylene group (polypropylene oxide; PO: —(CH₂CH₂CH₂O)ₙ—), and the like.

Further, examples of the alcohol group include a group derived from methanol, a group derived from ethanol, a group derived from propanol, a group derived from isopropanol, a group derived from glycerol, a group derived from polyglycerol, a group derived from trimethylolpropane, a group derived from pentaerythritol, a group derived from sorbitol, a group derived from sorbitan, a group derived from sucrose, a group derived from mannite, a group derived from glycol, and the like (for example, —CH₂CH₂OH in the case of ethanol).

A “hydrophobic part” indicates a hydrophobic portion contained in the molecular structure of the surfactant, and is preferably an aliphatic hydrocarbon group or an aromatic hydrocarbon group in which the main chain carbon number relative to a hydroxyl group is 4 or more and which is a group derived from an aliphatic alcohol, a group derived from an alkylphenol, a group derived from a fatty acid, or the like; a group derived from an organosiloxane, a group derived from an alkyl halide, or the like; or a combination thereof.

Examples of nonionic surfactants include silicone-based surfactants, acetylene glycol-based surfactants, fluorine-based surfactants, polyoxyethylene alkyl ether-based surfactants, polyoxypropylene alkyl ether-based surfactants, polyoxyethylene alkyl phenyl ether-based surfactants, polyoxypropylene alkyl phenyl ether-based surfactants, polyoxyethylene fatty acid ester-based surfactants, polyoxypropylene fatty acid ester-based surfactants, sorbitan fatty acid ester-based surfactants, polyoxyethylene sorbitan fatty acid ester-based surfactants, polyoxyethylene sorbitol fatty acid ester-based surfactants, and glycerol fatty acid ester-based surfactants. One nonionic surfactant may be used alone or a combination of two or more nonionic surfactants may be used

Among these, a silicone-based surfactant, an acetylene glycol-based surfactant, a fluorine-based surfactant, or a combination thereof is preferred.

An example of a commercially available product of an acetylene glycol-based surfactant is “ACETYLENOL E100” (product name) manufactured by Kawaken Fine Chemicals Co., Ltd. An example of a commercially available product of a silicone-based surfactant is “SILFACE SAG002” manufactured by Nissin Chemical Industry Co., Ltd.

One of the above surfactants may be used alone or a combination of two or more may be used.

The amount of the surfactant, expressed as the active component amount, relative to the total amount of the pretreatment liquid is preferably 0.1% to 5% by mass, more preferably 0.5% to 3% by mass, and even more preferably 0.5% to 2% by mass.

The pretreatment liquid may contain an additive, if necessary. Examples of additives include antioxidants, UV absorbers, infrared absorbers, and crosslinking agents.

In order to obtain jetting properties suitable for an inkjet method, the viscosity of the pretreatment liquid at 23° C. is preferably 1 to 30 mPa·s, more preferably 3 to 20 mPa·s, and even more preferably 4 to 12 mPa·s.

The pH of the pretreatment liquid is preferably 3 to 10 and more preferably 4 to 8.

The method for producing the pretreatment liquid is not particularly limited, but a desired pretreatment liquid can be obtained by mixing together the components as appropriate. The resulting composition may be filtered by using a filter or the like. Further, various additives may also be added as appropriate.

The pretreatment liquid can be applied to the substrate by means of an inkjet method. The inkjet method is not particularly limited and may be any method such as a piezo method, an electrostatic method, or a thermal method. When an inkjet printing device is used, it is preferable that the pretreatment liquid be jetted from an inkjet head based on a digital signal, and the liquid droplets of the jetted pretreatment liquid be adhered to the substrate.

The pretreatment liquid is preferably applied to the substrate prior to printing using an ink.

<Inkjet Ink>

The ink set of one embodiment can contain an inkjet ink.

The ink preferably contains a colorant.

The ink may contain a pigment, a dye, or a combination thereof as the colorant.

Examples of dyes that can be used favorably as the dye include water-soluble dyes and dyes that have been made water-soluble by reduction or the like, selected from among basic dyes, acid dyes, direct dyes, soluble vat dyes, acid mordant dyes, mordant dyes, reactive dyes, vat dyes, and sulfide dyes. Further, dispersible dyes such as azo-based dyes, anthraquinone-based dyes, azomethine-based dyes, and nitro-based dyes can also be used favorably. One of these dyes may be used alone, or a combination of a plurality of dyes may be used.

The pigment can be preferably blended into the ink in the form of a pigment dispersion.

Examples of the pigment dispersion that can be used include one in which a pigment is dispersed in water with a pigment dispersant, one in which a self-dispersing pigment is dispersed in water, and one in which a microencapsulated pigment obtained by coating the pigment with a resin is dispersed in water.

Examples of pigments which can be used include organic pigments such as azo pigments, phthalocyanine pigments, polycyclic pigments, dye lake pigments, and inorganic pigments such as carbon blacks and metal oxides. Examples of azo pigments include soluble azo lake pigments, insoluble azo pigments, and condensed azo pigments. Examples of phthalocyanine pigments include metal phthalocyanine pigments and metal-free phthalocyanine pigments. Examples of polycyclic pigments include quinacridone-based pigments, perylene-based pigments, perinone-based pigments, isoindoline-based pigments, isoindolinone-based pigments, dioxazine-based pigments, thioindigo-based pigments, anthraquinone-based pigments, quinophthalone-based pigments, metal complex pigments, and diketopyrrolopyrroles (DPP). Examples of carbon blacks include furnace carbon black, lamp black, acetylene black, and channel black. Examples of metal oxides include titanium dioxide and zinc oxide. One of these pigments may be used alone or a combination of two or more of these pigments may be used.

From the viewpoints of the jetting stability and the storage stability, the average particle size of the pigment particles in the ink, expressed as the volume-based average value in a particle size distribution measured by means of a dynamic light scattering method, is preferably not more than 300 nm, more preferably not more than 150 nm, and even more preferably not more than 100 nm.

A self-dispersing pigment may be blended as a colorant. A self-dispersing pigment is a pigment in which a hydrophilic functional group has been introduced at the pigment surface by a chemical treatment or a physical treatment. The hydrophilic functional group introduced into the self-dispersing pigment is preferably a group that has ionicity, and by charging the pigment surface either anionically or cationically, the pigment particles can be stably dispersed in water by electrostatic repulsion. Examples of preferable anionic functional groups include carboxyl groups, sulfo groups, sulfino groups, sulfuric acid ester groups, phosphoric acid groups, phosphoric acid ester groups, phosphorous acid groups, and phosphorous acid ester groups. Preferred cationic functional groups include quaternary ammonium groups and quaternary phosphonium groups.

These hydrophilic functional groups may be bonded directly to the pigment surface or bonded via other atom groupings. Examples of other atom groupings include, but are not limited to, alkylene groups, phenylene groups, and naphthylene groups. Examples of the pigment surface treatment method include a diazotization treatment, a sulfonation treatment, a hypochlorous acid treatment, a humic acid treatment, and a vacuum plasma treatment.

Examples of products that can be used favorably as self-dispersing pigments include the CAB-O-JET series of products such as “CAB-O-JET 200”, “CAB-O-JET 300”, “CAB-O-JET 250C”, “CAB-O-JET 260M”, “CAB-O-JET 270”, “CAB-O-JET 400”, “CAB-O-JET 450C”, “CAB-O-JET 465M”, and “CAB-O-JET 470Y” manufactured by Cabot Corporation, and “BONJET BLACK CW-1”, “BONJET BLACK CW-2”, and “BONJET BLACK CW-4” manufactured by Orient Chemical Industries, Ltd. (wherein all of the above are product names).

From the viewpoints of print density and ink viscosity, the amount of the colorant in the ink relative to the total amount of the ink is preferably 0.1% to 20% by mass, more preferably 1% to 15% by mass, even more preferably 1% to 10% by mass, even more preferably 2% to 8% by mass, and even more preferably 2% to 6% by mass.

A pigment dispersant typified by polymeric dispersants and surfactants may be preferably used for the pigment to be stably dispersed in the ink.

One pigment dispersant may be used alone or a combination of two or more may be used.

In cases where a pigment dispersant is used, the amount of the pigment dispersant added varies depending on the type used and there are no particular limitations thereon. For example, the pigment dispersant, expressed as a mass ratio of the active component relative to a value of 1 for the pigment, can be added in an amount within a range of 0.005 to 0.2.

The ink preferably contains a surfactant.

Examples of surfactants that may be preferably used include anionic surfactants, cationic surfactants, amphoteric surfactants, nonionic surfactants, or a combination thereof. Among these, nonionic surfactants are particularly preferred. The surfactant may be, for example, a low-molecular weight surfactant or a polymer-based surfactant.

The HLB value of the surfactant is preferably 5 to 20 and more preferably 10 to 18.

Examples of the surfactant that may be used include those described above in relation to the pretreatment liquid, and the surfactant may be selected from among those described above in relation to the pretreatment liquid. A nonionic surfactant is preferred as the surfactant, and a silicone-based surfactant, an acetylene glycol-based surfactant, a fluorine-based surfactant, or a combination of these is more preferred.

A single surfactant may be used, or a combination of two or more surfactants may be used.

The amount of the surfactant, expressed as the active component amount, relative to the total amount of the ink is preferably 0.1% to 5% by mass, more preferably 0.5% to 3% by mass, and even more preferably 0.5% to 2% by mass.

The ink may also contain a binder resin. Examples of the binder resin include a water-dispersible resin, a water-soluble resin, and a combination thereof. The binder resin may be any of an anionic resin, a cationic resin, an amphoteric resin, and a nonionic resin, but an anionic resin, a nonionic resin, or a combination thereof is preferable.

Water-dispersible resins are preferred as the binder resins. The water-dispersible resins can be dispersed in water without being dissolved in water and form an oil-in-water (O/W) type emulsion. The water-dispersible resin is preferably contained in the ink in a dispersed state as resin particles. The water-dispersible resin may, for example, be blended into the ink in the form of a resin emulsion.

The average particle size of the water-dispersible resins (an average particle size measured on a volume basis by means of a dynamic light scattering method) is preferably 1 to 300 nm, more preferably 5 to 200 nm, and even more preferably 10 to 150 nm.

In terms of the type of water-dispersible resin used, the use of a resin that forms a transparent coating film is preferred.

Examples of the water-dispersible resins include: conjugated diene-based resins such as styrene-butadiene copolymers, methyl methacrylate-butadiene copolymers, and vinyl chloride-vinyl acetate copolymers; acrylic-based resins such as polymers of acrylic acid esters and methacrylic acid esters, or copolymers thereof with styrene or the like; vinyl-based resins such as ethylene-vinyl acetate copolymers; functional-group modified resins in which any of these resins has been modified with a monomer containing a functional group such as a carboxyl group; melamine resins; urea resins; polyurethane resins; polyester resins; polyolefin resins; silicone resins; polyvinyl butyral resins; and alkyd resins. Resin emulsions containing one of these resins may be used, but hybrid resin emulsions may also be used.

One of these water-dispersible resins may be used alone, or a combination of two or more water-dispersible resins may be used. The amount (solid fraction amount) of the water-dispersible resin in the ink is preferably 0.5% to 20% by mass, more preferably 1% to 20% by mass, and even more preferably 5% to 10% by mass.

One of the binder resins described above may be used alone or a combination of two or more may be used.

The amount of the binder resin relative to the total amount of ink is preferably 0.5% to 20% by mass, more preferably 1% to 20% by mass, and even more preferably 5% to 10% by mass.

The ink preferably contains water, and the main solvent may be water.

There are no particular limitations on the water, but it is preferably water in which ionic components are as minimal as possible. In particular, from the viewpoint of the pigment dispersion stability of the ink, the amount contained of polyvalent metal ions such as calcium is preferably small. For example, ion-exchanged water, distilled water, ultrapure water, or the like may be used as the water.

From the viewpoint of viscosity adjustment, the amount of water contained relative to the total amount of ink is preferably 20% to 90% by mass, more preferably 30% to 80% by mass, and even more preferably 40% to 70% by mass.

The ink preferably contains a water-soluble organic solvent. Organic compounds that are liquid at room temperature and can be dissolved in water can be used as the water-soluble organic solvent. It is preferable to use a water-soluble organic solvent that mixes uniformly with an equal volume of water at 1 atmosphere and 20° C. As the water-soluble organic solvent, those described above for the pretreatment liquid can be used, for example. One of these water-soluble organic solvents may be used alone, or a combination of two or more water-soluble organic solvents may be used provided that the solvents form a single phase with water.

From the viewpoints of wettability, moisture retention effect, viscosity adjustment, and the like, the amount of water-soluble organic solvent contained relative to the total amount of the ink may be 1% to 80% by mass, more preferably 10% to 50% by mass, and more preferably 20% to 40% by mass.

The ink may contain an additive, if necessary. Examples of additives include antioxidants, UV absorbers, infrared absorbers, and crosslinking agents.

In order to obtain jetting properties suitable for an inkjet ink, the viscosity of the ink at 23° C. is preferably 1 to 40 mPa·s, more preferably 3 to 20 mPa·s, and even more preferably 4 to 12 mPa·s.

The method for producing the ink is not particularly limited, but a desired ink can be obtained by mixing together the components as appropriate. For example, a dispersion device such as a beads mill may be used to enhance pigment dispersion.

Further, the obtained composition may be filtered using a filter or the like. Furthermore, various additives may be added as appropriate.

The ink can be applied to a substrate by means of an inkjet method. The inkjet method is not particularly limited and may be any method such as a piezo method, an electrostatic method, or a thermal method. When an inkjet printing device is used, it is preferable that the ink be jetted from an inkjet head based on a digital signal, and the liquid droplets of the jetted ink are adhered to the substrate.

The ink is preferably applied to the substrate to which the pretreatment liquid has been applied.

<Cleaning Liquid>

The ink set of one embodiment can contain a cleaning liquid.

The cleaning liquid can contain water, a water-soluble organic solvent, a surfactant with an HLB value of at least 10, and a metal salt A.

The cleaning liquid may contain the water-soluble organic solvent.

Organic compounds that are liquid at room temperature and can be dissolved in water can be used as the water-soluble organic solvent, and the use of a water-soluble organic solvent that mixes uniformly with an equal volume of water at 1 atmosphere and 20° C. is preferred. As the water-soluble organic solvent, those described above for the pretreatment liquid can be used, for example. One of these water-soluble organic solvents may be used alone, or a combination of two or more water-soluble organic solvents may be used provided that the solvents form a single phase with water.

The amount of the water-soluble organic solvent relative to the total amount of the cleaning liquid is preferably at least 1% by mass, more preferably at least 5% by mass, and even more preferably at least 10% by mass. Meanwhile, the amount of the water-soluble organic solvent relative to the total amount of the cleaning liquid is preferably not more than 50% by mass, more preferably not more than 40% by mass, and even more preferably not more than 30% by mass. The amount of the water-soluble organic solvent relative to the total amount of the cleaning liquid is 1% to 50% by mass, more preferably 5% to 40% by mass, and even more preferably 10% to 30% by mass, for example.

The cleaning liquid can contain a metal salt A. A monovalent metal salt, a polyvalent metal salt, or a combination thereof can be used as the metal salt A.

Examples of metal ions of the monovalent metal salt include lithium ions, potassium ions, and sodium ions.

Examples of anions of the monovalent metal salt include chloride ion (Cl⁻), nitrate ion (NO₃⁻), acetate ion (CH₃COO⁻), and sulfate ion (SO₄²⁻). Examples of the monovalent metal salt include nitrates, acetates, halides (for example, chloride, iodide, bromide, and the like), chlorates, and sulfates.

Specific examples of the monovalent metal salt includes lithium nitrate, potassium nitrate, sodium nitrate, lithium acetate, and sodium acetate.

The monovalent metal salt may be a hydrate or an anhydrate.

The polyvalent metal ions of the polyvalent metal salt are not particularly limited as long as they are divalent or higher metal ions. Examples of both the polyvalent metal ions and anions of the polyvalent metal salt include those described above in relation to the polyvalent metal salt of the aggregating agent in the pretreatment liquid.

Examples of the polyvalent metal salt include nitrates, acetates, halides (for example, chloride, iodide, bromide, and the like), chlorates, and sulfates. Examples of the polyvalent metal salt include calcium chloride, calcium nitrate, magnesium nitrate, magnesium sulfate, copper nitrate, calcium acetate, and magnesium acetate.

The polyvalent metal salt may be a hydrate or anhydrate.

The metal salt A is preferably a monovalent metal salt. This is because a monovalent metal salt tends not to cause the ink to aggregate compared with a polyvalent metal salt.

The amount of the monovalent metal salt relative to the total amount of the metal salt A contained in the cleaning liquid is preferably at least 80% by mass, more preferably at least 90% by mass, even more preferably at least 95% by mass, and even more preferably 100% by mass.

Lithium ions or potassium ions are preferred as the metal ions of the metal salt A from the viewpoint of better cleaning properties relative to the pretreatment liquid. A lithium salt, a potassium salt, or a combination thereof is preferred as the metal salt A.

Although the principle is not certain, for example, if ions liberated from the aggregating agent in the pretreatment liquid become poorly water-soluble foreign substances, it is speculated that due to the cleaning liquid containing the metal salt containing lithium or potassium having a relatively high ionization tendency, potassium salts and the like which are relatively soluble in water are formed in place of the poorly water-soluble foreign substances, and the amount of poorly water-soluble foreign substances can be reduced. Suppose that the pretreatment liquid contains a polyvalent metal salt, such as a calcium salt or magnesium salt, as the aggregating agent, for example. In this case, it is speculated that poorly water-soluble foreign substances (poorly water-soluble salts) such as calcium hydroxide are formed by the polyvalent metal ions in the pretreatment liquid, and if lithium salts or potassium salts are contained in the cleaning liquid, potassium salts and the like which are relatively soluble in water are formed in place of the poorly water-soluble foreign substances (poorly water-soluble salts) such as calcium hydroxide, and accordingly the amount of poorly water-soluble foreign substances can be reduced.

The cleaning liquid may contain one of the above metal salts A alone or two or more of the above metal salts A.

The amount of the metal salt A, expressed as the active component amount, relative to the total amount of the cleaning liquid is preferably at least 0.01% by mass, more preferably at least 0.02% by mass, and even more preferably at least 0.03% by mass. The amount of the metal salt A, expressed as the active component amount, relative to the total amount of the cleaning liquid is preferably not more than 2% by mass, more preferably not more than 1% by mass, even more preferably not more than 0.5% by mass, and even more preferably not more than 0.3% by mass. The amount of the metal salt A, expressed as the active component amount, relative to the total amount of the cleaning liquid is preferably 0.01% to 2% by mass, more preferably 0.01% to 1% by mass, even more preferably 0.02% to 0.5% by mass, and even more preferably 0.03% to 0.3% by mass.

The cleaning liquid preferably contains water, and the main solvent may be water.

There are no particular limitations on the water, but water containing as few ionic components as possible is preferred. Examples of the water include ion-exchanged water, distilled water, and ultrapure water.

The amount of water relative to the total amount of the cleaning liquid is preferably 40% to 99% by mass, more preferably 50% to 95% by mass, and even more preferably 60% to 90% by mass.

The cleaning liquid preferably contains a surfactant with an HLB value of 10 or more.

Examples of the surfactant with an HLB value of 10 or more that may be used include anionic surfactants, cationic surfactants, amphoteric surfactants, and nonionic surfactants, and one type or a combination of two or more types thereof may be used. Among these, nonionic surfactants are particularly preferred. The surfactant may be, for example, a low-molecular weight surfactant or a polymer-based surfactant.

Examples of the surfactant with an HLB value of 10 or more that may be used include those described above in relation to the pretreatment liquid, and the surfactant with an HLB value of 10 or more may be selected from among those described above in relation to the pretreatment liquid. As the surfactant with an HLB value of 10 or more, nonionic surfactants are preferred, and silicone-based surfactants, acetylene glycol-based surfactants, fluorine-based surfactants, or combinations thereof are more preferred.

The HLB value of the surfactant with an HLB value of 10 or more is preferably not more than 20 and more preferably not more than 18.

The HLB value of the surfactant with an HLB value of 10 or more is, for example, 10 to 20 and more preferably 10 to 18.

An example of a commercially available product of an acetylene glycol-based surfactant with an HLB value of 10 or more is “ACETYLENOL E100” (product name) manufactured by Kawaken Fine Chemicals Co., Ltd. An example of a commercially available product of a silicone-based surfactant with an HLB value of 10 or more is “SILFACE SAG002” (product name) manufactured by Nissin Chemical Industry Co., Ltd. An example of a commercially available product of a fluorine-based surfactant with an HLB value of 10 or more is “Capstone FS-30” (product name) manufactured by Chemours Company.

One surfactant with an HLB value of 10 or more may be used alone or a combination of two or more surfactants with an HLB value of 10 or more may be used.

The amount of the surfactant with an HLB value of 10 or more, expressed as the active component amount, relative to the total amount of the cleaning liquid is preferably 0.1% to 5% by mass, more preferably 0.5% to 3% by mass, and even more preferably 0.5% to 2% by mass.

The cleaning liquid may contain a surfactant with an HLB value of less than 10 in addition to the surfactant with an HLB value of 10 or more.

As the surfactant with an HLB value of less than 10, a surfactant with an HLB value of less than 10 may be selected from among those described above in relation to the pretreatment liquid. As the surfactant with an HLB value of less than 10, nonionic surfactants are preferred, and silicone-based surfactants, acetylene glycol-based surfactants, fluorine-based surfactants, or combinations thereof are more preferred.

From the viewpoint of better cleaning properties relative to the pretreatment liquid, the amount of the surfactant with an HLB value of less than 10 relative to the total amount of the cleaning liquid is preferably note more than 1% by mass, more preferably not more than 0.5% by mass, even more preferably not more than 0.1% by mass, and even more preferably 0% by mass.

From the viewpoint of better cleaning properties relative to the pretreatment liquid, the cleaning liquid preferably does not contain the surfactant with an HLB value of less than 10.

From the viewpoint of better cleaning properties relative to the pretreatment liquid, the amount of the surfactant with an HLB value of 10 or more relative to the total amount of surfactants contained in the cleaning liquid is preferably at least 50% by mass, more preferably at least 70% by mass, even more preferably at least 90% by mass, even more preferably at least 95% by mass, even more preferably at least 99% by mass, and even more preferably 100% by mass.

The cleaning liquid may contain an additive, if necessary. Examples of additives include antioxidants, UV absorbers, infrared absorbers, and crosslinking agents.

From the viewpoints of good cleaning properties relative to the pretreatment liquid and good storage stability of the cleaning liquid, the conductivity of the cleaning liquid at 5° C. is preferably at least 0.10 mS/cm, more preferably at least 0.15 mS/cm, and even more preferably at least 0.20 mS/cm. Meanwhile, from the viewpoints of good cleaning properties relative to the ink and good storage stability of the cleaning liquid, the conductivity of the cleaning liquid at 5° C. is preferably not more than 3.0 mS/cm, more preferably not more than 2.5 mS/cm, and even more preferably not more than 2.0 mS/cm or less.

The conductivity of the cleaning liquid at 5° C. is preferably 0.10 to 3.0 mS/cm, more preferably 0.15 to 2.5 mS/cm, and even more preferably 0.20 to 2.0 mS/cm.

The conductivity of the cleaning liquid at 5° C. can be measured using the compact electro conductivity meter B-771 manufactured by HORIBA, Ltd.

The conductivity of the cleaning liquid can be adjusted by, for example, adjusting the amount of metal salt in the cleaning liquid, adjusting the amount of water-soluble organic solvent in the cleaning liquid, or a combination thereof.

The viscosity of the cleaning liquid at 23° C. is preferably 1 to 30 mPa·s, more preferably 3 to 20 mPa·s, and even more preferably 4 to 12 mPa·s.

The pH of the cleaning liquid is preferably 5 to 9 and more preferably 6 to 8.

The method for producing the cleaning liquid is not particularly limited, but a desired cleaning liquid can be obtained by mixing together the components as appropriate. The resulting composition may be filtered by using a filter or the like. Further, various additives may also be added as appropriate.

The cleaning liquid can be used for cleaning an inkjet head and a path. The cleaning liquid may be applied to a nozzle face of the inkjet head or the path of the ink and/or pretreatment liquid, for example.

In the cleaning operation of the inkjet head, the nozzle face may be cleaned using the cleaning liquid, for example. Examples of this kind of cleaning operation include the method of applying the cleaning liquid to the nozzle face, the method of applying the cleaning liquid to the nozzle face and wiping the nozzle face using a wiper, and the method of wiping the nozzle face using a wiper to which the cleaning liquid has been applied.

The cleaning operation may be performed immediately before printing, immediately after printing, or both. The cleaning operation may be performed when a sensor or the like senses dirt on the nozzle face after printing a prescribed number of times.

For the cleaning operation, a container of cleaning liquid and a cleaning mechanism such as a wiper may be provided in the inkjet printing device.

As other methods, the dirt on the nozzle face may be manually wiped using the cleaning liquid when the nozzle face becomes dirty, or the nozzle face may be immersed in the cleaning liquid to dissolve and remove the ink. The path may also be cleaned by introducing the cleaning liquid into a container of pretreatment liquid or ink.

<Ink Set>

The ink set can contain at least the above-described pretreatment liquid, ink, and cleaning liquid. The ink set may contain two or more inks, for example. The ink set may contain a post-treatment liquid or the like.

The present disclosure includes the following embodiments, but the present invention is not limited to these embodiments.

<1> An ink set including:
an inkjet pretreatment liquid containing an aggregating agent;
an inkjet ink; and
a cleaning liquid that contains water, a water-soluble organic solvent, a surfactant with an HLB value of 10 or more, and a metal salt A, and has a conductivity of 0.10 to 3.0 mS/cm at 5° C.
   <2> The ink set according to <1>, in which the metal salt A contains at least one selected from the group consisting of a lithium salt and a potassium salt.
   <3> The ink set according to <1> or <2>, in which a conductivity of the cleaning liquid at 5° C. is 0.20 to 2.0 mS/cm.
   <4> The ink set according to any one of <1> to <3>, in which the cleaning liquid does not contain a surfactant with an HLB value of less than 10.

### EXAMPLES

The present invention will be described below in further detail using a series of examples, but the present invention is in no way limited by the following examples. In the following description, “%” represents “% by mass” unless specifically stated otherwise.

<Production of Metal Salt Aqueous Solution>

(Magnesium Acetate Solution)

A magnesium acetate solution was prepared by dissolving magnesium acetate tetrahydrate, manufactured by FUJIFILM Wako Pure Chemical Corporation, in ion-exchanged water such that a 30%-by-mass aqueous solution was obtained in terms of anhydrate.

(Lithium Nitrate Solution)

A lithium nitrate solution was prepared by dissolving lithium nitrate, manufactured by FUJIFILM Wako Pure Chemical Corporation, in ion-exchanged water such that a 10%-by-mass aqueous solution was obtained in terms of anhydrate.

(Potassium Nitrate Solution)

A potassium nitrate solution was prepared by dissolving potassium nitrate, manufactured by FUJIFILM Wako Pure Chemical Corporation, in ion-exchanged water such that a 10%-by-mass aqueous solution was obtained in terms of anhydrate.

(Sodium Acetate Solution)

A sodium acetate solution was prepared by dissolving sodium acetate, manufactured by FUJIFILM Wako Pure Chemical Corporation, in ion-exchanged water such that a 10%-by-mass aqueous solution was obtained in terms of anhydrate.

<Production of Pretreatment Liquid, Ink, and Cleaning Liquid>

Table 1 shows the formulations of pretreatment liquids 1 and 2. Table 2 shows the formulation of ink 1. Tables 3 to 5 show the formulations of cleaning liquids 1 to 15. The raw materials were mixed according to the formulations shown in the tables, stirred at 100 rpm for 30 minutes using a mix rotor, and filtered through a 5-μm nylon syringe filter to prepare the pretreatment liquids 1 and 2, the ink 1, and the cleaning liquids 1 to 15 individually.

In Tables 3 to 5, “Ex 1” to “Ex 11” respectively represent “Example 1” to “Example 11”, “C Ex 1” to “C Ex 5” respectively represent “Comparative Example 1” to “Comparative Example 5”, “CL 1” to “CL 15” respectively represent “cleaning liquid 1” to “cleaning liquid 15”, and “PTL 1” to “PTL 2” respectively represent “pretreatment liquid 1” to “pretreatment liquid 2”.

Details of the materials shown in Tables 1 to 5 are described below.

(Polyvalent Metal Salts)
Magnesium acetate solution: produced as above, magnesium acetate (in terms of anhydrate): 30% by mass

(Cationic Polymer)
Himax SC-506 (product name): cationic polymer manufactured by HYMO Co., Ltd., active component 60% by mass

(Metal Salt A)
Lithium nitrate solution: produced as above, lithium nitrate (in terms of anhydrate) 10% by mass
Potassium nitrate solution: produced as above, potassium nitrate (in terms of anhydrate) 10% by mass
Sodium acetate solution: produced as above, sodium acetate (in terms of anhydrate) 10% by mass

(Water-Soluble Organic Solvents)
Glycerol: manufactured by FUJIFILM Wako Pure Chemical Corporation
Propylene glycol: manufactured by FUJIFILM Wako Pure Chemical Corporation
Ethylene glycol monoethyl ether: manufactured by FUJIFILM Wako Pure Chemical Corporation

(Surfactant)
“SILFACE SAG002” (product name): silicone-based surfactant manufactured by Nissin Chemical Industry Co., Ltd., active component: 100% by mass
“ACETYLENOL E100” (product name): acetylene glycol-based surfactant manufactured by Kawaken Fine Chemicals Co., Ltd., active component: 100% by mass
“Capstone FS-30” (product name): fluorine-based surfactant manufactured by Chemours Company, active component: 25% by mass
“BYK-019” (product name): silicone-based surfactant manufactured by BYK-Chemie Japan K.K., active component: 60% by mass

(Self-Dispersing Pigment)
“CAB-O-JET 400” (product name): manufactured by Cabot Corporation, solid fraction: 15% by mass

(Binder Resin)
“NeoRez R-967” (product name): urethane resin emulsion, manufactured by DSM Coating Resins, LLC, resin fraction: 40% by mass

The HLB values of the surfactants in Tables 1 to 5 were obtained from the molecular structure of the surfactants according to the Griffin method by using the following formula (1).

HLB value=20×(formula weight of hydrophilic part)/(molecular weight of surfactant) formula (1)

The conductivity at 5° C. of the cleaning liquids in Tables 3 to 5 was measured using the compact electro conductivity meter “B-771” manufactured by HORIBA, Ltd.

<Evaluation>

1. Storage Stability of Cleaning Liquid

The cleaning liquid was placed in an airtight container and left in an environment of 70° C. for one week. After cooling the liquid until the liquid reached room temperature, the appearance was visually observed and an evaluation was made according to the following criteria. Tables 3 to 5 show the results.

Evaluation Criteria
A: cloudiness observed
C: cloudiness not observed

2. Mixing Stability

Mixing stability was evaluated as an indicator of the cleaning properties. In the combination of the cleaning liquid and the ink or pretreatment liquid shown in Tables 3 to 5, the cleaning liquid and the ink or pretreatment liquid were mixed at a mass ratio of 1:1. After the mixture was left at 60° C. for one month, whether foreign matter was present in the mixture was observed by using a laser microscope and an evaluation was made according to the following criteria. Tables 3 to 5 show the results.

Evaluation Criteria
A: occurrence of foreign matter is not observed
B: occurrence of foreign matter is observed, but the amount is not problematic in terms of actual use
C: occurrence of foreign matter can be observed all over

TABLE 1
Formulation of pretreatment liquid

| | | | Pre- | Pre- |
|---|---|---|---|---|
| | | | treat- | treat- |
| | | HLB | ment | ment |
| Unit: % by mass | | value | liquid 1 | liquid 2 |
| Polyvalent | Magnesium acetate solution | | 66.7 | |
| metal salt | (active component: | | | |
| | 30% by mass) | | | |
| Cationic | Himax SC-506 | | | 33.3 |
| polymer | (active component: | | | |
| | 60% by mass) | | | |
| Water- | Glycerol | | 1.0 | 1.0 |
| soluble | Propylene glycol | | 20.0 | 20.0 |
| organic | | | | |
| solvent | | | | |
| Surfactant | SILFACE SAG002 | 12 | 1.0 | 1.0 |
| | (active component: | | | |
| | 100% by mass) | | | |
| Water | Ion-exchanged water | | 11.3 | 44.7 |

| | | |
|---|---|---|
| Total (% by mass) | 100.0 | 100.0 |

TABLE 2
Ink formulation

| | | HLB | |
|---|---|---|---|
| Unit: % by mass | | value | Ink 1 |
| Self- | CAB-O-JET 400 | | 20.0 |
| dispersing | (solid fraction: 15% by mass) | | |
| pigment | | | |
| Binder resin | NeoRezR-967 | | 22.5 |
| | (solid fraction: 40% by mass) | | |
| Water-soluble | Glycerol | | 1.0 |
| organic | Propylene glycol | | 30.0 |
| solvent | | | |
| Surfactant | SILFACE SAG002 | 12 | 1.0 |
| | (active component: 100% by mass) | | |
| Water | Ion-exchanged water | | 25.5 |

| | |
|---|---|
| Total (% by mass) | 100.0 |

TABLE 3
Cleaning liquid formulation and evaluation result

| | | | Ex 1 | Ex 2 | Ex 3 | Ex 4 | Ex 5 | Ex 6 |
|---|---|---|---|---|---|---|---|---|
| Unit: % by mass | | HLB | CL 1 | CL 2 | CL 3 | CL 4 | CL 5 | CL 6 |
| | | value | | | | | | |
| Metal | Lithium nitrate solution | | 0.3 | | | | | |
| salt A | (active component: 10% | | | | | | | |
| | by mass) | | | | | | | |
| | Potassium nitrate | | | 0.3 | 0.3 | 0.3 | 3.5 | 0.2 |
| | solution | | | | | | | |
| | (active component: 10% | | | | | | | |
| | by mass) | | | | | | | |
| | Sodium acetate solution | | | | | | | |
| | (active component: 10% | | | | | | | |
| | by mass) | | | | | | | |
| Water- | Propylene glycol | | 20.0 | 20.0 | 20.0 | 10.0 | 20.0 | 20.0 |
| soluble | Ethylene glycol | | | | | | | |
| organic | monoethyl ether | | | | | | | |
| solvent | | | | | | | | |
| Surfactant | ACETYLENOL E100 | 13 | | | 1.0 | | | |
| | (active component: 100% | | | | | | | |
| | by mass) | | | | | | | |
| | Capstone FS-30 | 11 | 4.0 | 4.0 | | 4.0 | 4.0 | 4.0 |
| | (active component: 25% | | | | | | | |
| | by mass) | | | | | | | |
| | BYK-019 | ≤6 | | | | | | |
| | (active component: 60% | | | | | | | |
| | by mass) | | | | | | | |
| Water | Ion-exchanged water | | 75.7 | 75.7 | 78.7 | 85.7 | 72.5 | 75.8 |
| Total (% by mass) | | | 100.0 | 100.0 | 100.0 | 100.0 | 100.0 | 100.0 |
| Conductivity of cleaning liquid at 5° C. | | | 0.23 | 0.22 | 0.22 | 0.31 | 1.86 | 0.13 |
| (mS/cm) | | | | | | | | |
| Storage stability of cleaning liquid | | | A | A | A | A | A | A |
| Mixing | Ink | | Ink 1 | Ink 1 | Ink 1 | Ink 1 | Ink 1 | Ink 1 |
| stability | | | A | A | A | A | A | A |

| | | | | | | |
|---|---|---|---|---|---|---|
| Pretreatment liquid | PTL 1 | PTL 1 | PTL 1 | PTL 1 | PTL 1 | PTL 1 |

| | | | | | |
|---|---|---|---|---|---|
| A | A | A | A | A | B |

TABLE 4
Cleaning liquid formulation and evaluation result

| | | | Ex 7 | Ex 8 | Ex 9 | Ex 10 | Ex 11 |
|---|---|---|---|---|---|---|---|
| Unit: % by mass | | HLB | CL 6 | CL 7 | CL 8 | CL 9 | CL 10 |
| | | value | | | | | |
| Metal | Lithium nitrate solution | | | | | | |
| salt A | (active component: 10% | | | | | | |
| | by mass) | | | | | | |
| | Potassium nitrate | | 0.2 | | 0.2 | 10.0 | 10.0 |
| | solution | | | | | | |
| | (active component: 10% | | | | | | |
| | by mass) | | | | | | |
| | Sodium acetate solution | | | 0.3 | | | |
| | (active component: 10% | | | | | | |
| | by mass) | | | | | | |
| Water- | Propylene glycol | | 20.0 | 20.0 | | 20.0 | 20.0 |
| soluble | Ethylene glycol | | | | 10.0 | | |
| organic | monoethyl ether | | | | | | |
| solvent | | | | | | | |
| Surfactant | ACETYLENOL E100 | 13 | | | | | |
| | (active component: 100% | | | | | | |
| | by mass) | | | | | | |
| | Capstone FS-30 | 11 | 4.0 | 4.0 | 4.0 | 4.0 | 3.2 |
| | (active component: 25% | | | | | | |
| | by mass) | | | | | | |
| | BYK-019 | ≥6 | | | | | 0.3 |
| | (active component: 60% | | | | | | |
| | by mass) | | | | | | |
| Water | Ion-exchanged water | | 75.8 | 75.7 | 85.8 | 66.0 | 66.5 |
| Total (% by mass) | | | 100.0 | 100.0 | 100.0 | 100.0 | 100.0 |
| Conductivity of cleaning liquid at 5° C. | | | 0.13 | 0.22 | 0.19 | 2.90 | 2.89 |
| (mS/cm) | | | | | | | |
| Storage stability of cleaning liquid | | | A | A | A | A | A |
| Mixing | Ink | | Ink 1 | Ink 1 | Ink 1 | Ink 1 | Ink 1 |
| stability | | | A | A | A | B | B |

| | | | | | |
|---|---|---|---|---|---|
| Pretreatment liquid | PTL 2 | PTL 1 | PTL 1 | PTL 1 | PTL 1 |

| | | | | |
|---|---|---|---|---|
| A | B | B | A | B |

TABLE 5
Cleaning liquid formulation and evaluation result

| | | | C Ex 1 | C Ex 2 | C Ex 3 | C Ex 4 | C Ex 5 |
|---|---|---|---|---|---|---|---|
| Unit: % by mass | | HLB | CL 11 | CL 12 | CL 13 | CL 14 | CL 15 |
| | | value | | | | | |
| Metal | Lithium nitrate solution | | | | | | |
| salt A | (active component: 10% | | | | | | |
| | by mass) | | | | | | |
| | Potassium nitrate | | 0.1 | 12.0 | 0.3 | 0.2 | 12.0 |
| | solution | | | | | | |
| | (active component: 10% | | | | | | |
| | by mass) | | | | | | |
| | Sodium acetate solution | | | | | | |
| | (active component: 10% | | | | | | |
| | by mass) | | | | | | |
| Water- | Propylene glycol | | 20.0 | 20.0 | 20.0 | | 20.0 |
| soluble | Ethylene glycol | | | | | 20.0 | |
| organic | monoethyl ether | | | | | | |
| solvent | | | | | | | |
| Surfactant | ACETYLENOL E100 | 13 | | | | | |
| | (active component: 100% | | | | | | |
| | by mass) | | | | | | |
| | Capstone FS-30 | 11 | 4.0 | 4.0 | | 4.0 | |
| | (active component: 25% | | | | | | |
| | by mass) | | | | | | |
| | BYK-019 | ≤6 | | | 1.7 | | 1.7 |
| | (active component: 60% | | | | | | |
| | by mass) | | | | | | |
| Water | Ion-exchanged water | | 75.9 | 64.0 | 78.0 | 75.8 | 66.3 |
| Total (% by mass) | | | 100.0 | 100.0 | 100.0 | 100.0 | 100.0 |
| Conductivity of cleaning liquid at 5° C. | | | 0.05 | 3.31 | 0.18 | 0.08 | 3.29 |
| (mS/cm) | | | | | | | |
| Storage stability of cleaning liquid | | | C | C | A | C | C |
| Mixing | Ink | | Ink 1 | Ink 1 | Ink 1 | Ink 1 | Ink 1 |
| stability | | | B | C | B | B | C |

| | | | | | |
|---|---|---|---|---|---|
| Pretreatment liquid | PTL 1 | PTL 1 | PTL 1 | PTL 1 | PTL 1 |

| | | | | |
|---|---|---|---|---|
| C | B | C | B | C |

As shown in Tables 3 to 5, in Examples 1 to 11, good results were obtained for the storage stability of the cleaning liquid. Further in Examples 1 to 11, good results were obtained for both the mixing stability of the ink and the cleaning liquid and the mixing stability of the pretreatment liquid and the cleaning liquid. This indicates that excellent cleaning properties can be obtained for both the pretreatment liquid and the ink.

In Comparative Examples 1 and 4, in which the conductivity of the cleaning liquid at 5° C. was low, cloudiness was observed in the evaluation of the storage stability of the cleaning liquid. In addition, in Comparative Example 1 in which the conductivity of the cleaning liquid at 5° C. was lower than that of Comparative Example 4, it was shown that the result of the mixing stability between the pretreatment liquid and the cleaning liquid was inferior.

In Comparative Examples 2 and 5, in which the conductivity of the cleaning liquid at 5° C. was high, cloudiness was observed in the evaluation of the storage stability of the cleaning liquid. It is speculated that this is because the polarity of the cleaning liquid itself was too high and the clouding point of the surfactant decreased. It was also shown that the result of the mixing stability between the ink and cleaning liquid was inferior. It is thought that the interaction between the metal salt of the cleaning liquid and the ink became stronger and the ink aggregated.

In Comparative Example 3, in which a surfactant with a low HLB value was used, it was shown that the result of the mixing stability between the pretreatment liquid and the cleaning liquid was inferior.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. An ink set comprising:
an inkjet pretreatment liquid containing an aggregating agent;
an inkjet ink; and
a cleaning liquid that contains water, a water-soluble organic solvent, a surfactant with an HLB value of 10 or more, and a metal salt A, and has a conductivity of 0.10 to 3.0 mS/cm at 5° C.

2. The ink set according to claim 1, wherein
the metal salt A contains at least one selected from the group consisting of a lithium salt and a potassium salt.

3. The ink set according to claim 1, wherein
a conductivity of the cleaning liquid at 5° C. is 0.20 to 2.0 mS/cm.

4. The ink set according to claim 1, wherein
the cleaning liquid does not contain a surfactant with an HLB value of less than 10.
